(19) United States
(12) Patent Application Publication
(10) Pub. No.: US 2014/0164360 A1
(43) Pub. Date: Jun. 12, 2014

(54) CONTEXT BASED LOOK-UP IN E-READERS

(71) Applicant: MICROSOFT CORPORATION, Redmond, WA (US)

(72) Inventors: Radoslav Nickolov, Seattle, WA (US); Ming Liu, Bellevue, WA (US); Wei Zeng, Sammamish, WA (US); Raman Narayanan, Seattle, WA (US); Aleksandr Gil, Redmond, WA (US)

(73) Assignee: Microsoft Corporation, Redmond, WA (US)

(21) Appl. No.: 13/711,198

(22) Filed: Dec. 11, 2012

(51) Int. Cl. G06F 17/30

(52) U.S. Cl. CPC G06F 17/30011
USPC 707/722; 707/769

(57) ABSTRACT

Context based enhanced search capabilities are provided in conjunction with e-reader experience. A search query may be augmented based on a context of the displayed content, user information, and similar background data such that relevancy and context of search results may be focused in presentation to the user. Context of content may include terms or objects near a selected portion of the content for search, a type of the displayed content, etc. Search results may be presented from a variety of sources categorized and/or prioritized based on system default parameters and/or user preferences.

### BACKGROUND

Mobile computing has transformed media consumption across markets. Miniaturization across product generations has enabled more functionality to be accomplished by smaller devices. A modern smartphone has more computing capacity than a desktop computer a few years ago. Mature product processes have also enabled advances in technology to be integrated to automated production of mobile devices seamlessly. Extensive automation has led to inexpensive components. Inexpensive components have enabled manufacturing of inexpensive mobile devices providing functionality on the go.

Recently, content has been making an accelerated march towards digital. Professionally published books and magazines are the most recent segment moving to digital domain with a variety of reader devices and platforms offering different aspects of user experience. Providers of e-reading services aim for compelling devices, satisfying reading experiences, rich catalog of digitized content with an easy commerce experience, a walled backend increasingly capable of hosting multiple content types, and early features in annotations and sharing features.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing context based enhanced search capabilities in conjunction with e-reader experience. A query such as a list of words that may or may not include particular phrases or other query semantics may be submitted to a search engine based on user action or automatically based on selection of one or more words. The query may be augmented based on a context of the displayed content, user information, and similar background data such that relevancy and context of search results may be focused in presentation to the user. Search results may be presented from a variety of sources and detail results from selected sources may be displayed upon selection.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example architectural diagram of providing context based look-up in e-readers according to some embodiments;

FIG. 2 illustrates an example of context based search in an e-reader application according to embodiments;

FIG. 3 illustrates an example of presenting summary and detailed search results for a context based search in an e-reader application according to embodiments;

FIG. 4 illustrates examples of context sources for a context based search in an e-reader application according to embodiments;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of providing context based search in an e-reader application according to embodiments.

### DETAILED DESCRIPTION

As briefly described above, a query may be submitted to a search engine based on user action or automatically based on selection of one or more words. The query may be augmented based on a context of the displayed content, user information, and similar background data such that relevancy and context of search results may be focused in presentation to the user.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing context based search in an e-reader application. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

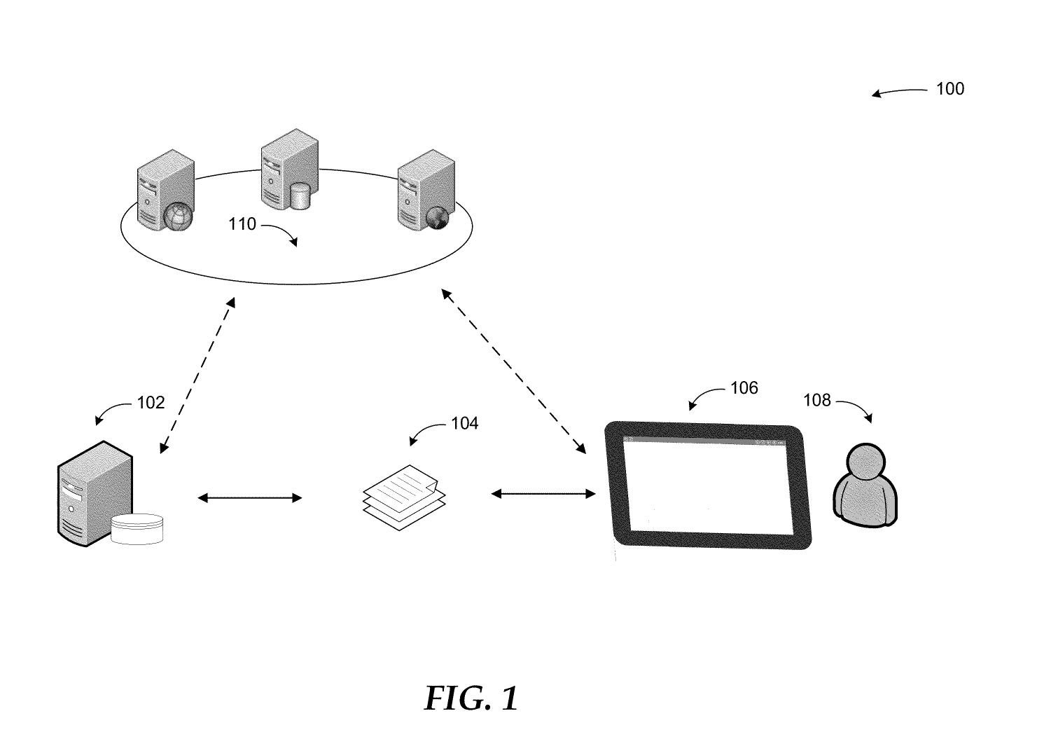

FIG. 1 illustrates an example architectural diagram of providing context based look-up in e-readers according to some embodiments. The components and environments shown in diagram 100 are for illustration purposes. Embodiments may be implemented in various local, networked, cloud-based and similar computing environments employing a variety of computing devices and systems, hardware and software.

An “e-reader” device such as a tablet 106 may host an application providing content 104 to a user 108. Such an application may be called an e-reader application, which may be a locally installed and executed application receiving content (e.g., e-books, documents, etc.) through wired or wireless networks. The e-reader application may also be a hosted service provided by one or more servers and accessed by a user through the e-reader device (e.g., tablet 106). Content may be any type of consumable data including but not exclusive to text, audio, video, graphic, etc. Content may also include media combinations presented in a standardized format (i.e.: a web page.) Content may be provided by a content server 102 hosting the content for consumption by services and devices.

An e-reader application according to embodiments may present content such as an e-book, a magazine article, a newspaper, or even a personal document to user 108 through tablet device 106 and enable enrichment of user experience through context based searches. Upon detecting a direct user action (e.g., activation of a search control following selection of a portion of displayed content) or automatically upon selection of a portion of the content, the e-reader application may submit a query to one or more search resources 110 (e.g., search engines, databases, etc.). The query may be augmented with context information based on the displayed content (e.g., type of content, information around the selected portion, etc.), the user (e.g., user credentials), or other information such that more focused and relevant search results can be provided to the user.

Embodiments are not limited to implementation in a tablet 106. In addition to touch or gesture enabled interactions, other input mechanisms such as standard mouse and keyboard interface, gyroscopic input devices, eye-tracking, and similar inputs may also be employed.

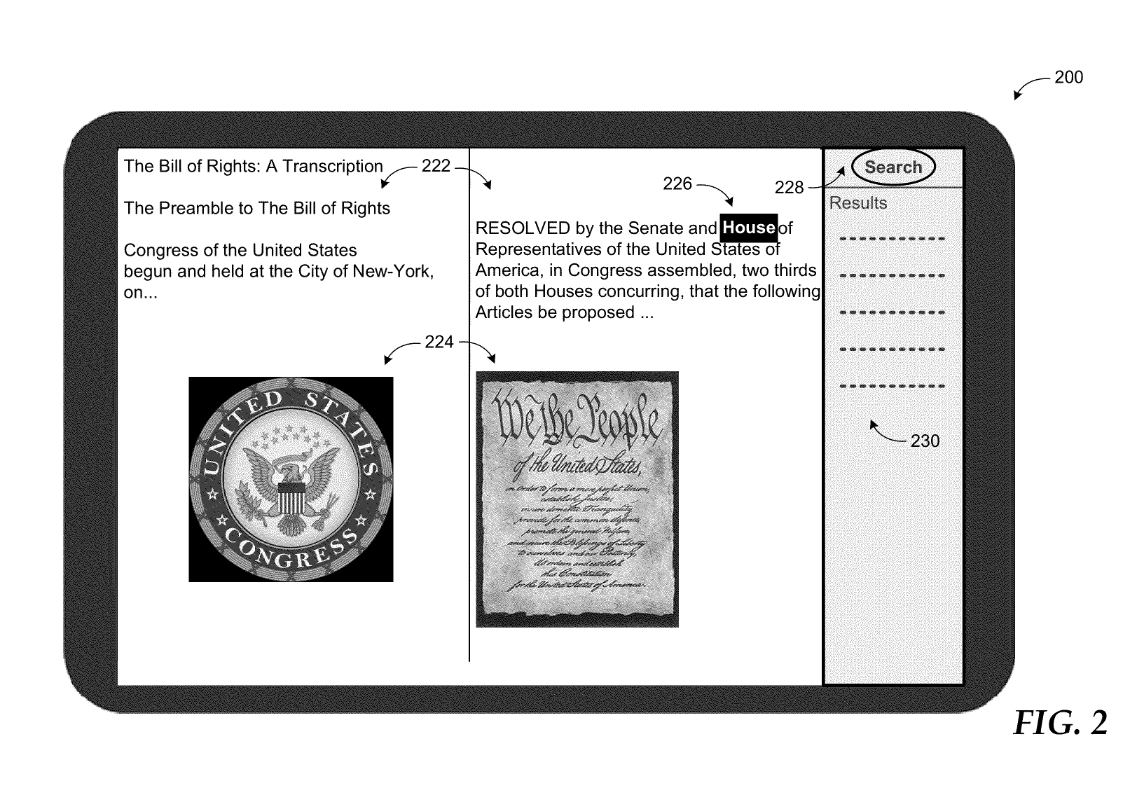

FIG. 2 illustrates an example of context based search in an e-reader application according to embodiments. Diagram 200 displays user interface of an e-reader application presenting textual content with graphics and a search pane presenting search results for a selected portion of the textual content.

In the example scenario of diagram 200, the displayed content is about the Bill of Rights with references to Congress, the Senate, and the House of Representatives. The displayed content includes textual portions 222 and graphics 224. A user may select a portion of the textual content, for example, the word “House” 226 and activate a search by activating the search control 228. In some embodiments, the search may be activated automatically upon detection of the selection of the word “House” 226. Search results may be presented in a search pane 230.

The word “House” selected in the displayed content clearly references the House of Representatives. However, a search without context may return a large number of results associated with irrelevant definitions or uses of the word house (e.g., real estate, households, etc.) potentially degrading user experience. To provide the user with a more focused and relevant search experience, an e-reader application according to embodiments may determine contextual information based on the content and user, and augment a search query with the context information.

The context information may include, for example, terms within a predefined vicinity of the selected term for search, a title of the displayed content, a type of displayed content (e.g., book, article, personal document), etc. The context information may further include user information such as user credentials, social networking information, professional networking information, friends who are also reading the content, and comparable information.

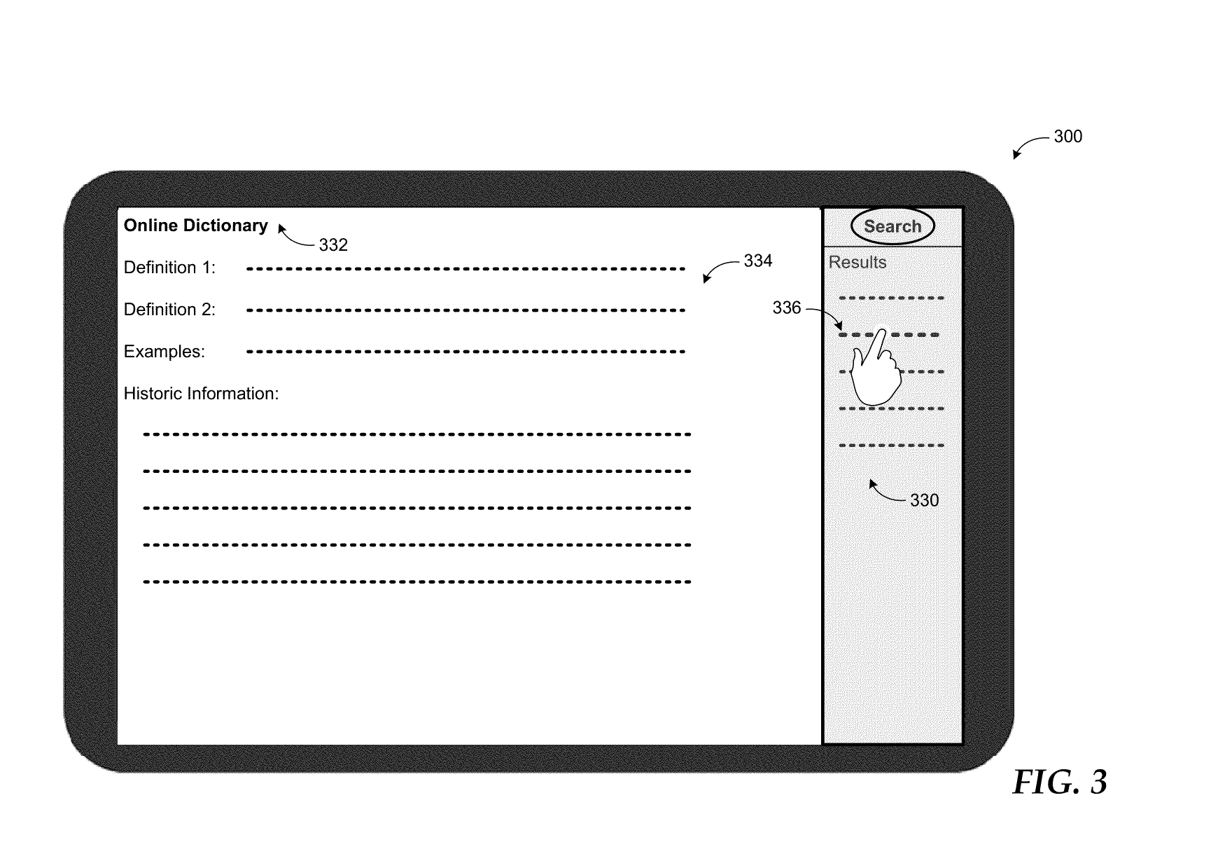

FIG. 3 illustrates an example of presenting summary and detailed search results for a context based search in an e-reader application according to embodiments. Content of interest may be searched with results being shown within the reading experience. For example, content of an e-book may be searched in a library (of user's books and other content associated with the e-reader application) and user notes along with a web search during the look-up process. For example, a selected word may be searched online and/or through user's domain based on the context of content around that word. Results may be provided in categories such as images, maps, text, scholarly articles, and similar groups based on the context and/or user preferences. Diagram 300 displays an example presentation of search results.

As shown in the diagram, a summary of search results, for example categorized by the groups listed above or by another categorization criterion may be presented in the search results pane 330. The results may be textual, but may also be augmented with graphics and/or images. Upon selection of one of the search results 336 in the search results pane 330, details of that result may be displayed in place of the original content in the main view pane.

In one example implementation, the search results may be displayed according to source. For example, online information consolidators may be listed with high priority, followed by educational information sources, newspapers, dictionaries, etc. Local sources such as user's own library or document folders may also be listed. Under each category a limited number of representative (e.g., top two or top three) results may be listed. Upon selection of one of those results, more search results 334 and more information associated with each item may be displayed under the source's name (332) in the main viewing pane.

In other examples, the user may be provided with the options of performing the search (e.g., web and/or local) upon selection of a portion of displayed content (e.g. words). The results may be explored further from within the results pane—while the content of the book or document remains in view. For example, the user may be able to select a link in the search results and view selected information on a separate browser user interface or a secondary user interface opened by the e-reader application.

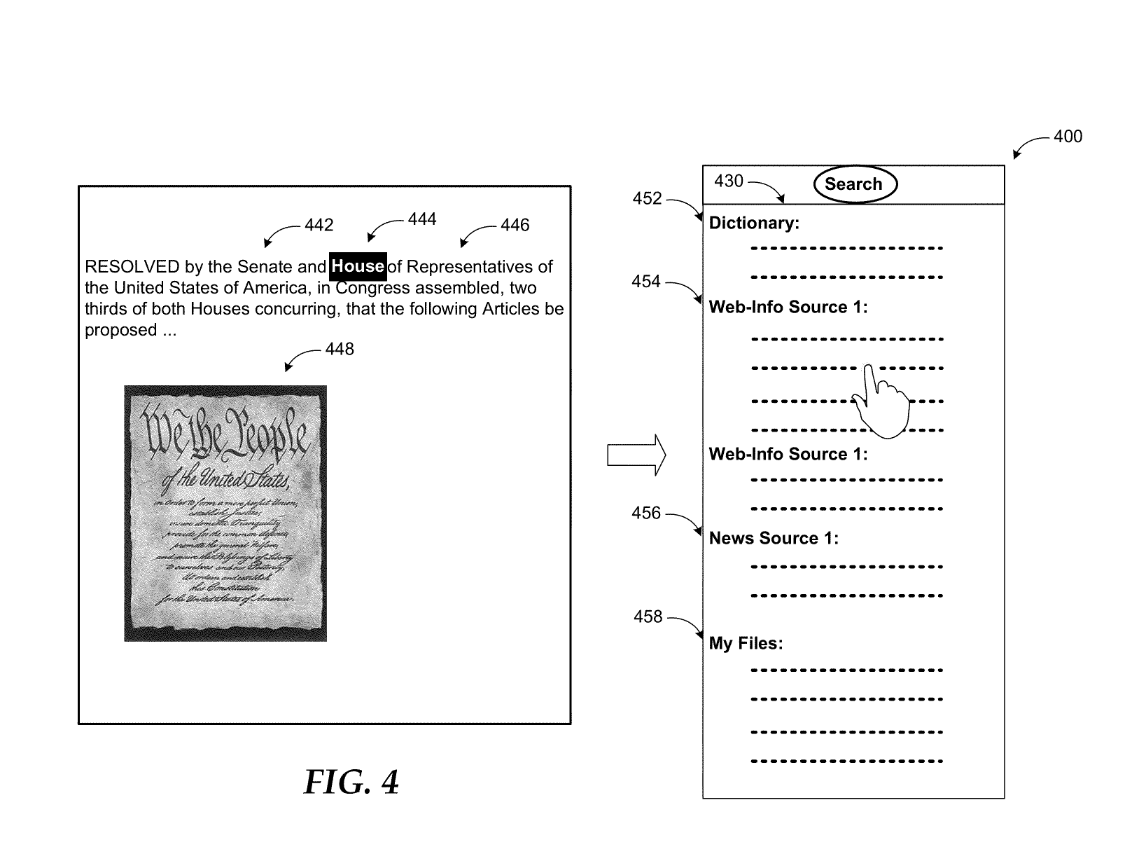

FIG. 4 illustrates examples of context sources for a context based search in an e-reader application according to embodiments. The context information may include user information such as the user's identity, the user's affiliation with an organization, a social network, a professional network, or others such as friends or peers who are also reading the content.

Another source for the context may be the content itself. For example, a title of the displayed content, a type of displayed content (e.g., book, article, personal document), etc. may be used to augment the search query. As shown in diagram 400, content elements around the selected portion for search may be used to augment the query as well. For example, words in a predefined vicinity of the selected term for search may be used for context. In the displayed example, the selected term is “House” 444. As discussed previously, the word house, alone, may have a multitude of meanings irrelevant to the word “House” 444 in the displayed content, which refers to the House of Representatives. Using nearby terms like “Senate” 442 and “Representatives” 446 to augment the query, a large portion of the irrelevant results may be filtered out. In some embodiments, non-textual content such as a nearby image 448 may also be used to augment the query, for example by employing image recognition. Thus, context around the selected work may enable entity extraction and disambiguation for more relevant results.

Diagram 400 also shows an example search results pane 430, where the search results are categorized under “Dictionary” 452, web information sources 454, news sources 456, and user's files 458. The categorization may be based on default parameters of the e-reader application or a search engine used by the e-reader application, as well as user preferences. In some examples, the categorization may be dynamically adjusted based on displayed content. For example, if the user is viewing a scientific article, scholarly information sources may be prioritized in results categorization and presentation. Similarly, if the user is viewing a novel, literary information sources may be prioritized.

Furthermore, the categorization may be dynamically adjusted based on selected portion of the displayed content. For example, if the user selects a geographic location or and address, map sources may be prioritized; if the user selects a character name in a literary work, sources associated with literary works including those about characters may be prioritized in presentation.

The example scenarios and configurations in FIG. 1 through 4 are shown with specific objects, data types, and configurations. Embodiments are not limited to systems according to these example configurations. Providing context based search in an e-reader environment may be implemented in configurations employing fewer or additional components in applications and user interfaces. Furthermore, the example schema and components shown in FIG. 1 through 4 and their subcomponents may be implemented in a similar manner with other values using the principles described herein.

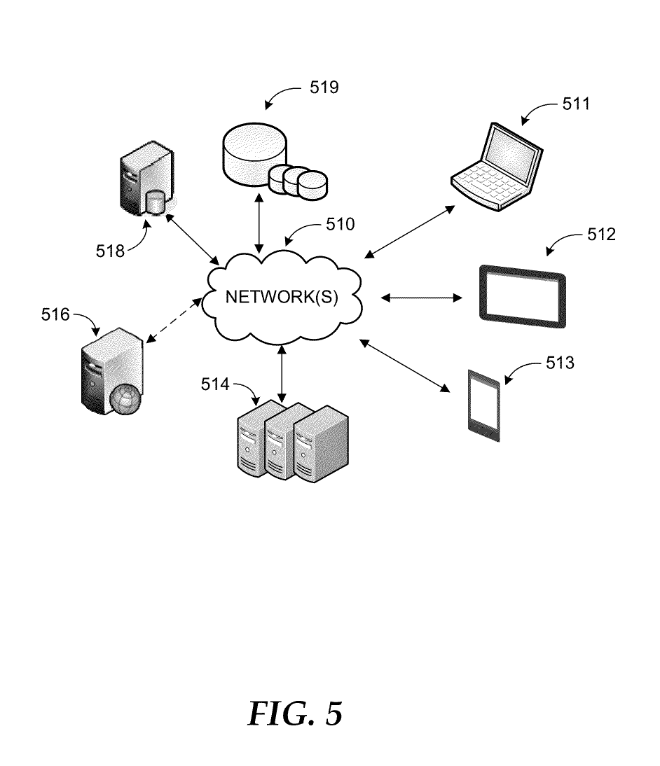

FIG. 5 is a networked environment, where a system according to embodiments may be implemented. Local and remote resources may be provided by one or more servers 514 or a single server (e.g. web server) 516 such as a hosted service. An e-reader application may execute on individual computing devices such as a smart phone 513, a tablet device 512, or a laptop computer 511 (‘client devices’) and communicate with a content resource through network(s) 510.

As discussed above, an e-reader application may provide context based search in an e-reader environment. Content and/or user related information may be used to augment a search query and results may be prioritized, categorized, and/or presented based on based on default parameters, user preferences, and/or content type. Client devices 511-513 may enable access to applications executed on remote server(s) (e.g. one of servers 515) as discussed previously. The server(s) may retrieve or store relevant data from/to data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to providing context based search in an e-reader environment. Furthermore, the networked environments discussed in FIG. 5 are for illustration purposes only. Embodiments are not limited to the example applications, modules, or processes.

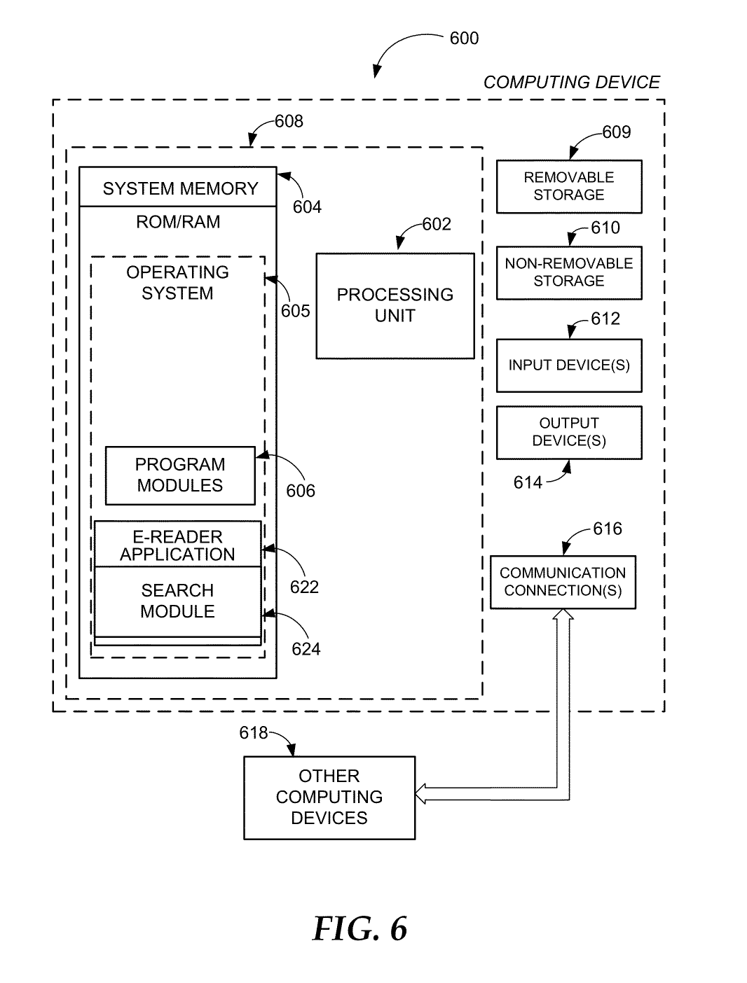

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® and WINDOWS PHONE® operating systems from MICROSOFT CORPORATION of Redmond, Wash. The system memory 604 may also include one or more software applications such as program modules 606, an e-reader application 622, and a search module 624.

An e-reader application 622 may submit a query such as a list of words that may or may not include particular phrases or other query semantics to a search engine through the search module 624 based on user action or automatically based on selection of one or more words. The query may be augmented based on a context of the displayed content, user information, and similar background data such that relevancy and context of search results may be focused in presentation to the user. Search results may be presented from a variety of sources and detail results from selected sources may be displayed upon selection. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. Computer readable storage media is a computer readable memory device. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, storage servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

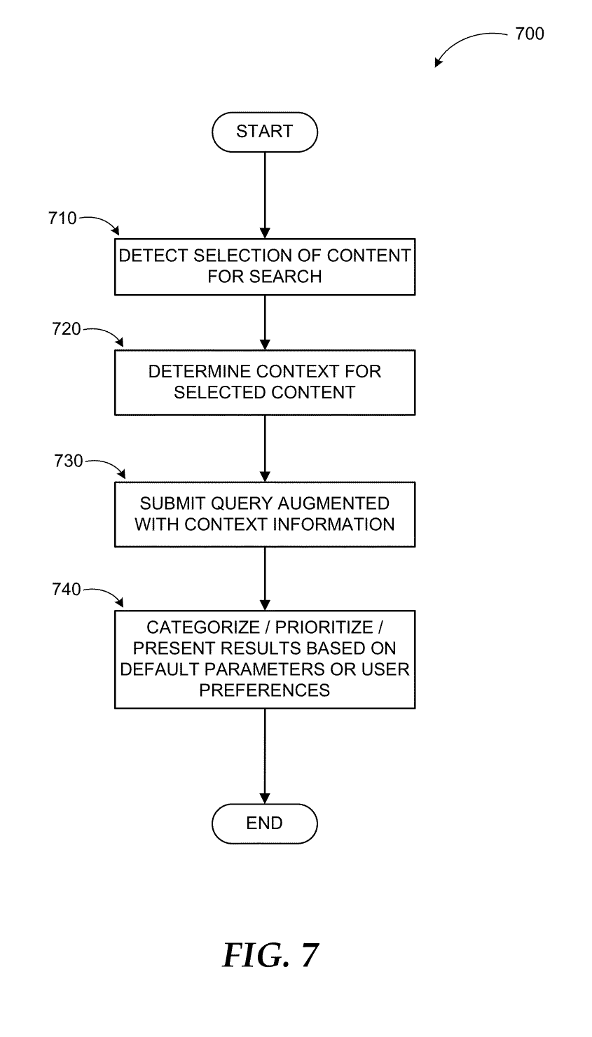

FIG. 7 illustrates a logic flow diagram for a process of providing context based search in an e-reader application according to embodiments. Process 700 may be implemented by an e-reader application in some examples.

Process 700 may begin with operation 710 where the e-reader application may detect selection of a portion of displayed content for search purposes. The search may be initiated automatically upon selection or by direct user action such as activation of a search control. At operation 720, the application may determine a context for the selected content portion such as terms in a vicinity, title or type of the displayed content, user information, etc.

At operation 730, a search query may be submitted to a search engine augmented with the context information such that results can be focused to more relevant information. The search may be executed in one or more of web resources, a user library associated with an e-reader application, a collection of user documents, and/or a collection of user notes generated through the e-reader application. At operation 740, returned results may be categorized, prioritized, and/or presented based on system default parameters and/or user preferences, as well as content type.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 700 are for illustration purposes. Providing context based search in an e-reader application, according to embodiments, may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for providing context based search in an e-reader environment, the method comprising:
detecting selection of a portion of displayed content;
generating a query for a search based on the selected portion;
determining a context of the selected portion in relation to the displayed content and a user viewing the displayed content; and
augmenting the query based on the context.

2. The method of claim 1, further comprising:
one or more of categorizing, prioritizing, and presenting search results in response to the augmented query based on one or more default parameters of an e-reader application.

3. The method of claim 2, further comprising:
customizing one or more of the categorization, prioritization, and presentation of the search results based on one or more of user preferences.

4. The method of claim 2, further comprising:
enabling exploration of the results within a results view pane while the displayed content remains in view.

5. The method of claim 2, further comprising:
upon detecting selection of one of the presented results in a results view pane, presenting detailed information associated with the selected result in one of a main view pane replacing the displayed content, a separate user interface managed by a browser, and a secondary user interface managed by the e-reader application.

6. The method of claim 1, further comprising:
generating the query in response to detecting activation of a search control following the selection of the portion of the displayed content.

7. The method of claim 1, further comprising:
determining the context from one or more of at least one term within a predefined vicinity of a term in the selected portion, a title of the displayed content, and a type of displayed content.

8. The method of claim 7, further comprising:
determining the context from one or more of an image, a graphic, an audio object, and a video object within a predefined vicinity of a term in the selected portion.

9. The method of claim 7, wherein the type of displayed content includes one of an e-book, a magazine article, a newspaper article, professional document, and a personal document.

10. The method of claim 1, further comprising:
enabling execution of the search in one or more of web resources, a user library associated with an e-reader application, a collection of user documents, and a collection of user notes generated through the e-reader application.

11. A computing device for providing context based search in an e-reader environment, the computing device comprising:
a memory configured to store instructions; and
a processor coupled to the memory, the processor executing an e-reader application in conjunction with the instructions stored in the memory, wherein the e-reader application is configured to:
detect selection of a portion of displayed content;
generate a query for a search based on the selected portion;
determine a context of the selected portion in relation to the displayed content and a user viewing the displayed content;
augment the query based on the context; and
one or more of categorize, prioritize, and present search results in response to the augmented query based on one or more of a default parameter of an e-reader application and a user preference.

12. The computing device of claim 11, wherein the e-reader application is further configured to:
one or more of categorize, prioritize, and present the search results based on one of the displayed content and the selected portion of the displayed content.

13. The computing device of claim 11, wherein the e-reader application is further configured to:
enable interaction for a user through one or more of a touch input, a gesture input, a mouse input, a keyboard input, a gyroscopic input, and an eye-tracking input.

14. The computing device of claim 11, wherein the search results include textual, image, and graphic content.

15. The computing device of claim 11, wherein the e-reader application is further configured to:
determine the context from one or more of an image and a graphic within a predefined vicinity of a term in the selected portion employing image recognition.

16. The computing device of claim 11, wherein the e-reader application is one of a locally executed application and a client application accessing an e-reader service.

17. A computer-readable memory device with instructions stored thereon for providing context based search in an e-reader environment, the instructions comprising:
detecting selection of a portion of displayed content;
generating a query for a search based on the selected portion;
determining a context of the selected portion in relation to the displayed content and a user viewing the displayed content;
augmenting the query based on the context; and
one or more of categorizing, prioritizing, and presenting search results in response to the augmented query based on one or more of a default parameter of an e-reader application, a user preference, the displayed content, and the selected portion of the displayed content.

18. The computer-readable memory device of claim 17, wherein the instructions further comprise:
categorizing the search results based on one or more of a source of each result, a type of each result, and a format of each result.

19. The computer-readable memory device of claim 17, wherein the instructions further comprise:
enabling entity extraction and disambiguation for enhanced relevancy of the search results through the context based augmentation of the query.

20. The computer-readable memory device of claim 18, wherein the instructions further comprise:
enabling automatic augmentation of the displayed content based on the search results.
